(19) United States
(12) Patent Application Publication
(10) Pub. No.: US 2007/0196546 A1
(43) Pub. Date: Aug. 23, 2007

(54) Method and apparatus for removing contaminants from an alcoholic beverage

(76) Inventor: Elia Rocco Tarantino, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/703,584

(22) Filed: Feb. 6, 2007

Related U.S. Application Data
(60) Provisional application No. 60/774,435, filed on Feb. 17, 2006.
(60) Provisional application No. 60/855,025, filed on Oct. 27, 2006.

(51) Int. Cl. A23C 9/14

(52) U.S. Cl. 426/271

(57) ABSTRACT

A method of removing or reducing a component of a foodstuff is disclosed. One method utilizes an ion exchange resin configured with a strongly basic counter-ion such as a quaternary amine. The strongly basic anion may be exchanged with a second anionic group such as hydroxyl, or a weak acid anion such as bicarbonate, carbonate, acetate, phosphoric and carboxylate to create an ion exchange resin comprising substantially a second group functionality. Sulfite containing beverages such as wines, beers, whiskeys or non-alcoholic beverages may be contacted with the ion exchange resin having the second group functionality to entrain a substantial quantity of the sulfites in the ion exchange resin and reduce the sulfite level of the beverage.

### RELATED APPLICATION DATA

This application claims priority to U.S. Provisional Application Ser. No. 60/774,435, filed Feb. 17, 2006, and U.S. Provisional Application Ser. No. 60/855,025, filed Oct. 27, 2006.

### FIELD OF THE INVENTION

This invention relates generally to methods for reducing undesired components, such as contaminants, from foodstuffs such as alcoholic beverages.

### RELATED ART

Foodstuffs such as beverages often contain various components which are undesireable. These components may be naturally occurring, may be additives, or may be contaminants. For example, sulfites are added to various foodstuffs including beverages for various reasons, including for stabilizing food colors and acting as preservatives to prevent spoilage due to bacteria and fungi. Sulfites are commonly found in alcoholic beverages such as wines. Wines may include up to about 3 ppm (parts per million) sulfur dioxide produced during yeast metabolism. In addition, during wine production, up to about 30 ppm of sulfites may intentionally be added. Similarly, beer and other alcoholic beverages may contain significant quantities of sulfites and other sulfur derivatives originating from metabolites and due to deliberate addition during production.

Unfortunately, some individuals are highly sensitive to certain foodstuff components such as sulfites. Such individuals may have allergic reactions upon ingesting sulfite containing foods or beverages, ranging from discomfort such as headaches to death in very severe cases.

U.S. government regulations have stringent standards regarding the level of sulfites in consumables. However, there is still a considerable industrial need to continue the use of sulfites as color stabilizers and preservatives. For individuals who are sensitive to sulfites, improved methods for reducing sulfites in alcoholic beverages are highly desirable.

The safety of such individuals would be enhanced together with their enjoyment of products that are generally available to the public.

### SUMMARY OF THE INVENTION

The invention comprises methods and apparatus for removing or reducing certain components of foodstuffs.

In accordance with one embodiment of the invention, a sulfite removing/reducing additive or material is associated with a sulfite containing foodstuff, such as an alcoholic beverage. The additive may be located in a container containing the beverage, such as by dropping or releasing a caplet, capsule or other form of the material into the container. Alternatively, the material may be associated with a spout, cap, container lid or the like and the beverage may be placed into contact with the material.

The invention also comprises various sulfite removing/reducing materials or additives. According to one embodiment of the invention, an ion exchange resin is configured with a strongly basic counter-ion such as a quaternary anion. The strongly basic anion is exchanged with a hydroxyl group to create an ion exchange resin providing hydroxyl functionality. When the ion exchange resin having hydroxyl functionality contacts a sulfite containing foodstuff, such as a beverage, the sulfites are entrained in the ion exchange resin, and the sulfite level of the foodstuff is substantially reduced.

According to another embodiment of the invention, an ion exchange resin is configured with a strongly basic counter-ion and the basic counter-ion is exchanged with a weak acid anion such as bicarbonate, carbonate, acetate, phosphoric, carboxylates and the like. The ion exchange resin having the weak acid anion functionality may be contacted with a sulfite containing foodstuff, such as beverage. The sulfites may be entrained in the ion exchange resin, and the sulfite level of the beverage may be substantially reduced.

The methods and devices of the invention may be utilized to remove or reduce other components, such as contaminants, from foodstuffs such as beverages.

The foregoing and other articles, features, and advantages of the invention will be apparent from the following more detailed description of the preferred embodiments of the invention. The various features may be utilized or claimed alone or in any combination.

### DETAILED DESCRIPTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One or more embodiments of the invention comprise methods and apparatus/devices for removing or reducing one or more components of foodstuffs. These components may be contaminants, additives, or naturally occurring substances or elements. The invention has particular applicability to the removal or reduction of sulfites in foodstuffs such as alcoholic beverages.

In the context of this disclosure, the term “sulfites” as used herein includes the salts of sulfurous acids (M₂S₂O₃), acid-sulfites or bisulfites (MHSO₃), sulfur dioxide (SO₂), metabisulfites (M₂S₂O₅), hydrosulfites (M₂S₂O₄), combinations thereof and the like, wherein M represents a cationic counter-ion comprising one or metals or non-metals such as ammonium and derivatives thereof.

The methods and apparatus described herein may reduce the level of sulfites in currently available foodstuff products to substantially lower levels acceptable to individuals who are sensitive to ingestion of sulfites. Of course, the amount of sulfites may be lowered to any pre-determined level, but economic considerations in combination with the needs of allergy-susceptible individuals may favor less stringent methods.

The term “alcoholic beverage” includes any ethanol containing liquid such as wine, beer, whiskey and the like. Though the description provided herein is primarily with reference to alcoholic beverages, the methods and apparatus described herein may also be utilized in conjunction with a variety of foodstuffs other than alcoholic beverages, such as non-alcoholic beverages or other items to be ingested.

In one embodiment of the invention, a sulfite removing or reducing additive or material is placed into contact with a sulfite containing foodstuff, such as a beverage. Various embodiments of sulfite removing or reducing additives or materials are described in more detail below. These additives may be solid or semi-solid.

In one embodiment, one or more sulfite removing or reducing additives are associated with an alcoholic beverage, whereby the additive entrains at least a portion of sulfites contained in the beverage. In one embodiment, the additive may be formed into a caplet or located in a capsule (or other container) so as to provide a specific size or dose of additive. The additive may be added directly to the desired beverage, such as by dropping the additive into a container containing the beverage (such as a wine bottle) or into a glass, which contains (or is to contain) the beverage.

In one embodiment, the additives might be associated with the packaging of the beverage. For example, one or more caplets or capsules may be placed into a package, which is attached to the container containing the beverage. The “dose” of the additive may be predetermined for the specific volume of the beverage in the container and/or the sulfite content of the beverage. Upon preparing to consume the beverage, a consumer may utilize the associated additive by opening the container and then placing the additive into contact with the beverage before its consumption.

The additive might also be formed into or associated with an item, which is placed into contact with the beverage, such as an ornamental object. The object might be a stir-stick.

The additive might otherwise be placed into contact with the beverage. For example, a portion of a container (such as a lid or cork or a bottom portion of the container) may comprise one or more sulfite removing or reducing additives. Of course, the additives may be located in any portion of the container. The additives may be located in a portion of the lid separated by a permeable membrane or may comprise a portion of the lid. In use, an individual might invert the container to assure contact between the container's fluid contents and the additive prior to consuming the fluid contents. In other embodiments, when a cork or lid of the container is removed, the additive may be released into the container into contact with the beverage.

In yet another embodiment, a beverage may be placed into contact with the additive along a flow path of the beverage. For example, a beverage in a first container may be discharged into one or more intermediary containers configured to reduce sulfite levels and then returned to the first container or another container prior to consumption of the beverage.

In an exemplary embodiment, at least a portion of the additives may comprise one or more ion exchange resins. By way of example, weakly basic anion exchange resins may include DOWEX™ 66 or DOWEX™ 77 manufactured by The Dow Chemical Company, U.S.A. DOWEX™ 66 and DOWEX™ 77 comprise a styrene DVB (divinyl benzene polymer) macro porous matrix including tertiary amine group functionality. The styrene DVB matrix comprises styrene cross-linked with divinyl benzene. It will be appreciated that the matrix may be any suitable polymer configured with a counter-ion. Weak anion exchange resins may be effective in reducing predominantly acidic sulfites, but not sulfites in their salt form. When the salt form of sulfites are present, a fluid may initially be de-cationized (that is the metal or non-metal counter-ion may be replaced with an acid group) with a strong acid cation exchange resin such as DOWEX™ 88 followed by treatment with a weakly basic anion exchange resin as discussed above. DOWEX™ 88 comprises a styrene DVB (divinyl benzene polymer) macro porous matrix including sulfonic acid group functionality. Of course any weakly basic and strongly acidic ion exchange resins may be suitably utilized.

In another exemplary embodiment, a strongly basic anion exchange resin such as DOWEX™ 22 may be utilized to reduce sulfites in a beverage. DOWEX™ 22 comprises a styrene DVB (divinyl benzene polymer) macro porous matrix including quaternary amine group functionality. In an embodiment of a DOWEX™ 22 ion exchange resin, the quaternary amine group functionality may be initially exchanged with hydroxyl group. The quaternary amine group may comprise trimethyl ammonium, poly (acrylamido-N-propyltrimethylammonium chloride) or any other suitable quaternary amine. The hydroxyl group of the ion exchange resin may be exchanged for sulfite anions thereby permitting entrainment sulfites in the ion exchange resin when the ion exchange resin contacts the sulfite containing fluid (alcoholic or non-alcoholic beverage). In operation, sulfite anion levels may be substantially reduced in the beverage.

In another embodiment of a DOWEX™ 22 ion exchange resin, the quaternary amine group functionality may be initially exchanged with bicarbonate anion (HCO₃⁻). The bicarbonate group of the ion exchange resin may be exchanged for sulfite anions thereby permitting entrainment sulfites in the ion exchange resin when the ion exchange resin contacts the sulfite containing fluid. Excess bicarbonate remaining in the fluid may degas as carbon dioxide (CO₂), and the fluid may subsequently achieve a slightly acidic pH as is well understood. Since the level of sulfites in most consumable beverages is very low (less than about 30-70 parts per million), an increased acidity of the fluid would be imperceptible in use.

In yet another embodiment, the quaternary amine group functionality of DOWEX™ 22 ion exchange resin may be initially exchanged with carbonate anion (CO₃²⁻). When carbonate group of the ion exchange resin exchanges for sulfite anions thereby entraining sulfites in the ion exchange resin on contact with sulfite containing fluids, any insoluble carbonates may precipitate out, while soluble carbonates will remain in solution. Again, since the level of sulfites in most consumable beverages is very low any precipitates would be imperceptible.

It will be appreciated that any weak acid anion such as bicarbonate, carbonate, acetate, phosphoric, carboxylate and combinations thereof, and the like may exchange out quaternary bases of DOWEX™ 22 ion exchange resins (or any other ion exchange resin having a quaternary base functionality). Furthermore, ion exchange resins may be suitably sized to provide greater contact area and more efficient ion exchange capability.

The method and apparatus of the invention may be utilize to remove or reduce other components from a foodstuff. For example, a similar method and apparatus might be utilized to remove or reduce tannins (polyphenols), histamines or other components/contaminants from wine. Of course, the additive which is utilized in such a method or apparatus might vary, depending upon the particular components to be reduced/removed.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method of reducing sulfites in a beverage comprising the steps of:
providing an ion exchange resin configured with a strongly basic counter-ion; exchanging the strongly basic anion with a second anionic group to create an ion exchange resin comprising substantially a second group functionality; and contacting the ion exchange resin having the second group functionality with a beverage including sulfites to entrain a substantial quantity of the sulfites in the ion exchange resin, and thereby reduce the sulfite level of the beverage.

2. The method in accordance with claim 1 wherein said step of contacting said ion exchange resin with a beverage comprises dropping a capsule containing said resin in a container containing said beverage and dissolving at least a portion of said capsule to place said resin in contact with said beverage.

3. The method in accordance with claim 1 wherein said step of contacting said ion exchange resin with a beverage comprises dropping a capsule comprising said resin in a container containing said beverage.

4. The method in accordance with claim 1 wherein said step of contacting said ion exchange resin with a beverage comprises pouring said beverage over a material comprising said resin.

5. The method in accordance with claim 1 wherein said step of contacting said ion exchange resin with a beverage comprises piercing a membrane in a container separating said beverage from said resin, permitting said beverage to contact said resin.

6. The method in accordance with claim 1 wherein said step of contacting said ion exchange resin with a beverage comprises associating said resin with a stirrer and stirring said beverage with said stirrer.

7. The method in accordance with claim 1 wherein said beverage comprises wine.
